(19) United States
(12) Patent Application Publication
(10) Pub. No.: US 2013/0073370 A1
(43) Pub. Date: Mar. 21, 2013

(54) Method and Apparatus for Issuing Municipal Credit Cards for Future Tax Credits and Other Incentives

(71) Applicant: Kirk B. Burkley, Pittsburgh, PA (US)

(72) Inventor: Kirk B. Burkley, Pittsburgh, PA (US)

(21) Appl. No.: 13/622,631

(22) Filed: Sep. 19, 2012

Related U.S. Application Data
(60) Provisional application No. 61/536,304, filed on Sep. 19, 2011.

(51) Int. Cl. G06Q 30/02

(52) U.S. Cl. 705/14.32

(57) ABSTRACT

A system and method for offering tax incentives for credit card usage includes partnering, between a municipality and a credit card issuer, to issue a credit card sponsored by the municipality, wherein the municipality receives a percentage of every transaction charged to the card, tracking, by a reporting and tracking computer, card usage by the users via transactions charged to the card, and offering, from a municipality computer, tax incentives, by the municipality, to users based on card usage.

### CROSS-REFERENCE TO RELATED APPLICATIONS

This patent application claims the benefit of co pending U.S. Provisional Patent Application No. 61/536,304, filed on Sep. 19, 2011, the disclosure of which is hereby incorporated by reference in its entirety.

### FIELD OF THE INVENTION

The present disclosure is directed toward a method and apparatus for issuing credit cards and, more particularly, toward the issuing of municipal credit cards that can allow the individual users of the card to receive tax reductions and other benefits while, at the same time, allowing the municipality to receive revenue through an up-front partnering payment and/or a percentage of revenue received from card usage. This is not a tax strategy but, rather, a method/apparatus for enabling municipalities (e.g., boroughs, townships, cities, counties, states, etc.) to generate revenue without raising taxes through the issuance of a virtually risk free credit card.

### BACKGROUND OF THE INVENTION

Municipalities today are facing ever increasing financial strain in performing government-related services. In the United States, factors such as recession, a declining tax basis, unemployment, an aging population, and a shift in responsibilities between state and below state level government bodies and the federal government are some of the factors which are contributing to this increased financial strain. As used herein, a “municipality” is any government entity, such as, for example, boroughs, townships, cities, counties, states, agencies, authorities, etc.

A natural solution to create additional funds would be to raise tax revenue through increasing tax rates (e.g., property taxes, sales taxes, income taxes, etc.) and the like. However, increasing taxes is generally unfavored and unpopular, especially in times of recession, and is often viewed as furthering the recession by taking funds from individuals that could have otherwise been spent on purchases and by denying businesses the monies needed for investment and the hiring of new employees. In times of financial strain, municipalities are thus faced with the need to find innovative ways of creating additional revenue without levying additional taxes.

In an attempt to raise revenue without raising taxes, municipal entities have partnered with private entities to operate public assets. However, a common problem with such projects is that the private investors may obtain a rate of return that is higher than the government's bond rate, even though most or all of the income risk associated with the project is borne by the public sector. Additionally, these attempts at solving the budget crisis do not incentivize people to spend money, either within or without the municipal boundaries, and thus have been limited in their ability to raise additional revenue.

What is therefore needed is a mechanism by which municipalities can raise revenue that is relatively inexpensive, virtually risk-free and attractive to residents, while at the same time incentivizing people to spend money, particularly within the jurisdiction of the municipality, if applicable.

The present disclosure is directed toward overcoming one or more of the above-identified problems.

### SUMMARY OF THE INVENTION

The present invention is a method and vehicle for tracking revenue created by credit cards issued for the purpose of delivering fees to municipal entities. A municipality would receive up-front payment for partnering with a card issuer and sponsoring a credit card. As a sponsor of the credit card, the municipality would receive a percentage of all revenue received from card usage (i.e., a percentage of every transaction charged to the card). The up-front payment and percentage can be negotiated between the municipality and the credit card issuer. Computer programs and devices can track card usage as a whole and the percentage of revenue generated through card usage to be transmitted to the municipality. Computer programs and devices can also track card usage on an individual basis and the expected revenue to the municipality through use of individual cards, thus allowing a municipality to give tax reductions to individual users (who are residents of the municipality or otherwise taxed or charged fees by the municipality) if their card usage is high enough. The computer programs and devices can further differentiate between card usage within the municipality and outside of the municipality, thus allowing the municipality to give more credit on taxes or other benefits for usage inside the municipality due to the additional tax revenue that would be generated/created by such usage from sales and employment within the municipality.

The inventive method and vehicle encourages or otherwise incentivizes people to spend money in a certain municipality (typically their municipality of residence), and to spend such money by using a specific credit card to do so. The computer programs and devices will track spending and spending habits and provide tax incentives and other benefits to individuals who use the card. It will not cost the tax payer any additional money, and will put additional funds in the coffers of the municipality. The municipality could also partner with non-profit or for profit entities to have them to use the municipal credit cards for purchases in lieu of taxes or in return for a reduction in taxes.

In one embodiment, a method is provided for offering tax incentives for credit card usage. The method includes the steps of: partnering, between a municipality and a credit card issuer, to issue a credit card sponsored by the municipality, wherein the municipality receives a percentage of every transaction charged to the card; tracking, by a reporting and tracking computer, card usage by the users via transactions charged to the card, wherein the card usage data is stored in a database connected to the reporting and tracking computer; analyzing, by the reporting and tracking computer, the card usage data to determine an extent of card usage; and offering, from a municipality computer, tax incentives, by the municipality, to users based on the analyzed card usage. The tax incentives can be offered to users based on overall card usage by the user, based on usage of the card by the user within the municipality, or based on a combination of overall card usage by the user and usage of the card by the user within the municipality. Generally, the tax incentives increase as usage of the card increases. The tax incentives can include tax discounts or not raising tax rates by the municipality. In one form, the users can be individuals or business entities (non-profit or for profit). In another form, the inventive method includes the stop of partnering, between the municipality and a local entity, to offer additional awards, other than tax incentives, to users based on card usage. Examples of additional awards could be the municipality partnering with local sports teams to give away free tickets or passes to municipal assets, such as, for example, swimming pools, libraries, museums, etc.

In another embodiment, a system for offering tax incentives for credit card usage is provided. The system includes: a credit card issuer computing device issuing a credit card sponsored by a municipality, wherein the municipality receives a percentage of every transaction charged to the card; a reporting and tracking computing device connected to the credit card computing device via a communications network, the reporting and tracking computing device receiving information regarding transactions charged to the card via the communications network and tracking card usage by the users, wherein the card usage data is stored in a database connected to the reporting and tracking computer, and wherein the reporting and tracking computer analyzes the card usage data to determine an extent of card usage; and a municipality computing device connected to the reporting and tracking computing device via the communications network, the municipality computing device offering tax incentives to users based on card usage as tracked and analyzed by the reporting and tracking computing device.

The tax incentives can be offered to users based on overall card usage by the user, based on usage of the card by the user within the municipality, or based on a combination of overall card usage by the user and usage of the card by the user within the municipality. Generally, the tax incentives increase as usage of the card increases. The tax incentives can include tax discounts or not raising tax rates by the municipality. The card users can be individuals or business entities (non-profit or for profit). In particular, many non-profits are large land owners in any particular municipality and may generate millions or even billions of dollars in revenue. There is significant pressure on municipalities to find ways to tax or otherwise realize revenue from non-profit entities. The municipality could partner with non-profits so that the non-profit entities would utilize the sponsored credit card to make all or some purchases on the card, or utilize the card for executive or other employee expense accounts. This would be revenue and cost neutral for the non-profit (they are spending the money anyway), but could generate huge sums of additional revenue for the sponsoring municipality.

In one form, the municipality computing device can offer additional awards, other than tax incentives, to users based on card usage based on a partnership between the municipality and a local entity. The municipality could partner with local sports teams or corporations to offer rewards, such as, for example, tickets to events, passes to cultural events, free products and services from local companies and other benefits to incentivize people to spend money locally and use the card to do so.

It is an object of the present method and apparatus to provide a municipal credit card which individuals can use to offset or reduce taxes.

It is a further object of the present method and apparatus to provide a municipality with a vehicle by which they can raise revenue at low or no cost and without the need for raising tax rates.

In some instances, the municipality can dedicate revenue from the sponsored credit card to a particular purpose, such as underfunded pension obligations, or public assets such as swimming pools, libraries, etc. In other instances, the municipality could allow a user to elect where the revenue from the user's card should be directed. Implementing this sort of “dedicated revenue” would encourage people and corporations to participate in the program.

Other objects, aspects and advantages of the present disclosure can be obtained from a study of the specification, the drawings, and the appended claims.

### BRIEF DESCRIPTION OF THE DRAWINGS

FIG. 1 illustrates an exemplary computer architecture for carrying out the disclosed exemplary municipal credit card issuance method in the present disclosure;

FIG. 2 illustrates an exemplary computer architecture for a device for carrying out the disclosed exemplary municipal credit card issuance method in the present disclosure;

FIG. 3 is a flow chart illustrating, at a conceptual level, the method steps employed by the present disclosure; and

FIG. 4 depicts an exemplary computer system in which embodiments of the present disclosure may be implemented.

### DETAILED DESCRIPTION OF THE INVENTION

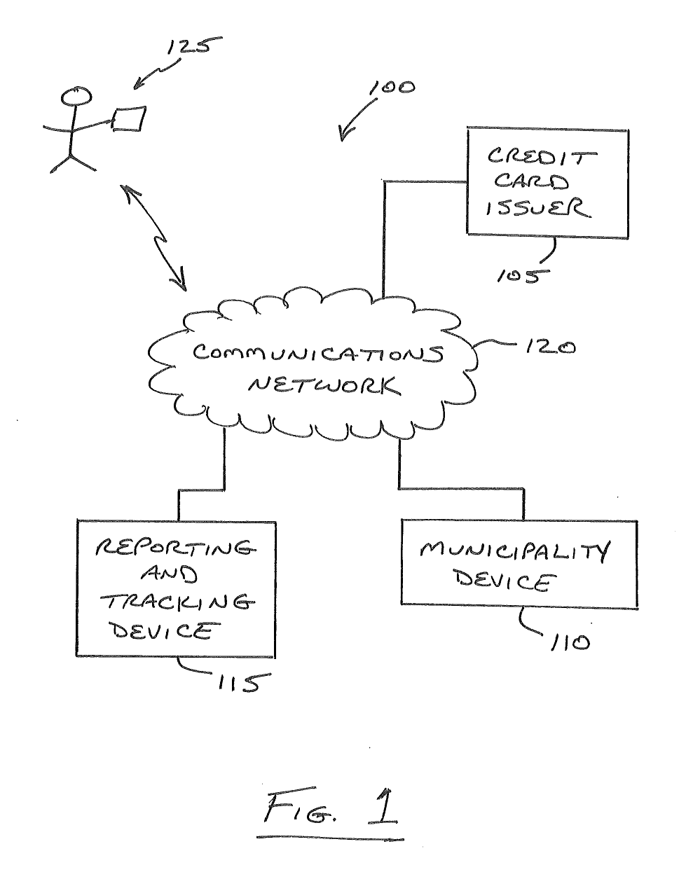

FIG. 1 illustrates an exemplary computer architecture, shown generally at 100, for carrying out the disclosed exemplary municipal credit card issuance method. The architecture 100 includes a credit card issuer 105, a municipality device 110, and a reporting and tracking device 115, all connected with each other through a communications network 120, such as, for example, the Internet. The credit card issuer 105 may be, for example, a Visa® card issuer, a MasterCard® card issuer, a Discover® card issuer, etc.

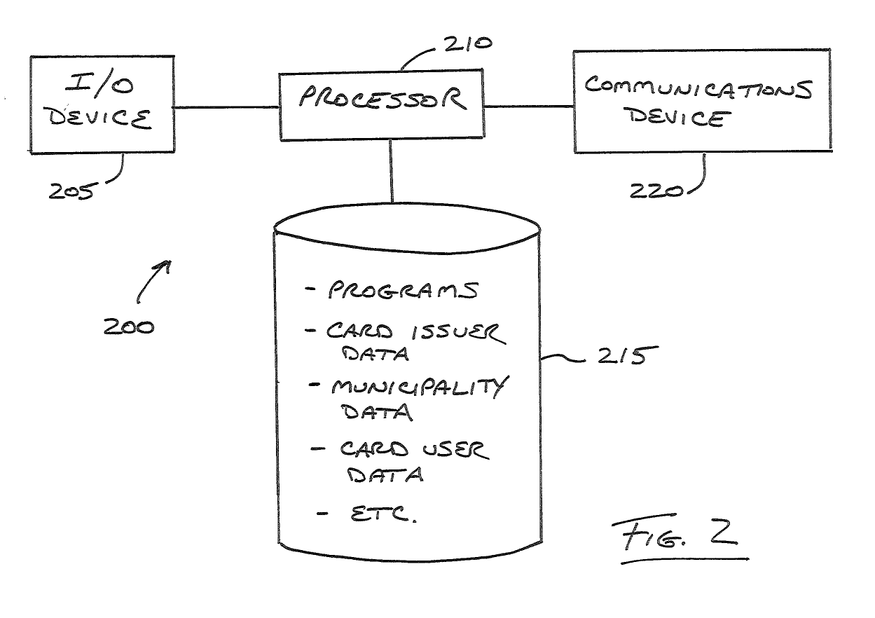

Each of the devices 105, 110, 115 may be a general purpose computer suitable for use in performing the functions described herein. FIG. 2 illustrates a general block diagram of a general purpose computer which may be utilized for each of the devices 105, 110, 115. As shown in FIG. 2, each computing device 200 includes an input/output device 205 for receiving data and instructions from, and communicating information and results to, a user, processor 210 (e.g., a CPU), a memory 215 (e.g., random access memory (RAM) and/or read only memory (ROM)), and a communications device 220 (e.g., receiver/transmitter) for communication with other devices via the communications network 120. Stored in the memory are the various programs run on the computing device 200, as well as other information relevant to the disclosed system and method, such as, for example, card issuer data, municipality data, card user data, card usage data, etc. It should be understood that each device 105, 110, 115 may not initially include all of the relevant card issuer, municipality and card user data but, as the transaction(s) takes place, this information will be transferred between devices.

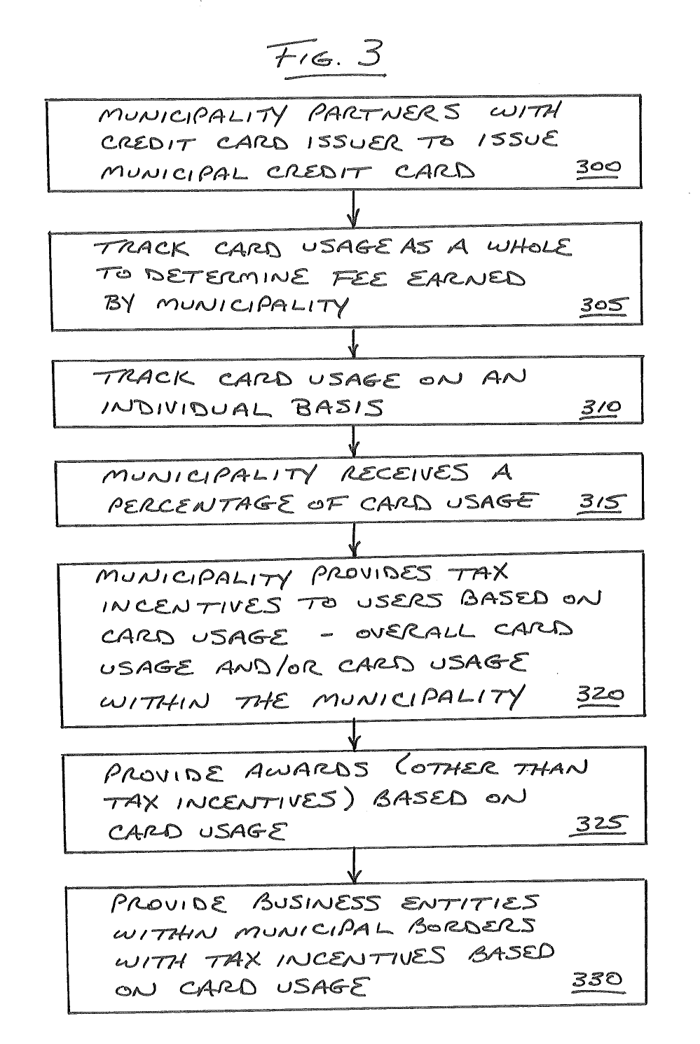

As shown in FIG. 3, the method generally begins with the municipality partnering with a credit card issuer 105 to issue a card for that municipal entity, at step 300. The municipal entity can also be considered as a sponsor of the card. The municipality then promotes the card to its citizens or residents or those that do business in the general area. Of course, promotion of the card is not limited to citizens or residents of the municipality. The municipality typically receives an up-front payment for partnering with the card issuer 105 and sponsoring a credit card. As a sponsor of the credit card, the municipality also receives a percentage of all revenue received from card usage. The up-front payment and percentage are generally negotiated between the municipality and the credit card issuer.

Since the municipality earns a fee on all revenue generated by use of the card, the reporting and tracking device 115 tracks spending on the cards, at step 305. The tracking and reporting device 115 also tracks individual card usage, at step 310. For example, when a user 125 uses his/her card to make a purchase, the purchase data is transmitted to the reporting and tracking device 115 via the communications network 120 and stored on associated database. The purchase data is used by the reporting and tracking device 115 to track card usage as a whole and individual card usage. The card usage data is analyzed by the reporting and tracking device and, based on the analyzed data, the card user receives certain incentives. The reporting and tracking device 115 shares this tracked data with both the card issuer 105 and the municipality device 110. The municipality, at predetermined intervals, receives a percentage of transaction amounts of the card usage, at step 315. The more the card is used for purchases by the card holders, the more revenue that will be received by the municipality. For example, say the municipal credit card is issued to 5,000 persons. Each person spends $15,000 using the card in a given year. If the municipality receives 1% of the transaction amount of usage of the card, the municipality would receive $750,000. A 2% rate for card usage would earn the municipality $1,500,000. These are revenues raised by the municipality at low or no cost and without the need for raising tax rates. In addition to earning a percentage of the transactions on the card, the municipality could earn a percentage of other fees and interest earned from the card usage and payment.

As an incentive to use the credit card, the municipality will provide tax incentives for users (e.g., citizens and residents) who use the card at approved levels, at step 320. Those incentives would increase based upon card usage. The incentives can be based on either overall usage, or usage within the municipal borders that produce additional tax revenue, or a combination of both. The reporting and tracking device 115, as well as other computer programs and devices contemplated herein, will calculate, analyze and track that usage. For example, if it can be determined that spending $10,000 within the municipal boundary creates $200 of tax revenue, the tax payer could receive discounts on taxes not to exceed $200. This determined tax revenue can be considered separate from the percentage of transaction usage that the municipality will also receive. At a 1% rate, $10,000 of general card usage would generate $100 for the municipality. In this instance, for example, a tax payer can receive a tax discount not to exceed $100.

As noted above, tax incentives can be based on overall usage. The incentives can increase for varying levels of usage. For example, card users can be given a certain tax discount for overall usage between $10,000-$20,000, and a greater tax discount for usage between $20,000-$40,000. As the amount of usage increases, the tax discount increases. The tax discount can be based on the amount the municipality expects to receive from the percentage of card transaction usage. The tax discount should not exceed the percentage amount that the municipality will receive. Separate tax discounts can be given based on overall usage and usage within the municipality, or a tax discount can be given based on a combination of overall usage and usage within the municipality. One skilled in the art will recognize that there are a myriad of possibilities for calculating tax discounts based on card transaction usage.

In one form, the municipality could also partner with local entities (i.e., one within the municipality's borders) to create programs and give out awards (other than tax discounts) based on usage, at step 325. Increasing levels of card usage could entitle the user to various awards, such as, for example, free parking, sports tickets, concert tickets, etc.

In addition, the municipality could make arrangements with business entities, such as non-profit entities and for profit entities, located within its borders and, in lieu of pressure to pay taxes or for tax incentives, the business entities could agree to use the municipal credit cards for purchases, at step 330. For example, a large non-profit hospital system could make all of its lab purchases (potentially in the hundreds of millions of dollars) using the municipal credit card. This would not cost the non-profit any additional money, but would send additional revenue to the host municipality. The municipality could offer the non-profit entity a tax discount based on usage. For example, at a 1% transaction rate, the municipality would receive $2,000,000 based on $200,000,000 of lab purchases by the non-profit hospital. Similar to the individual tax incentives, the business entity tax incentives could increase base on overall usage and/or usage within the municipality, or a combination of both.

It will be appreciated that one or more exemplary embodiments of the present invention can provide one or more advantages or none at all. For example, the municipality does not have to offer tax discounts as the tax incentives. The tax incentive can be that if the municipality can generate enough revenue through use of the card, then it will not have to raise tax rates. The system can employ hardware and/or software aspects. Software includes, but is not limited to, firmware, resident software, microcode, etc., that has been compiled to program a general purpose computer to be a specific purpose computer, or run a specific purpose computer. Software might be employed, for example, in connection with one or more of terminals of the credit card issuer 105, the municipality device 110, and the reporting and tracking device 115, all connected with each other through the communications network 120. Different method steps can be performed by different processors. The database memory 215 could be distributed or local and the processors could be distributed or singular. The memory devices could be implemented as an electrical, magnetic or optical memory, or any combination of these or other types of storage devices (including memory portions as described above with respect to cards). It should be noted that if distributed processors are employed, each distributed processor that makes up a processor carrying out a function or step generally contains its own addressable memory space. It should also be noted that some or all of computer systems can be incorporated into an application-specific or general-use integrated circuit. For example, one or more method steps could be implemented in hardware in an ASIC rather than using firmware. Displays used in conjunction with each of the entities and processors are representative of a variety of possible input/output devices.

Accordingly, it will be appreciated that one or more embodiments of the present disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

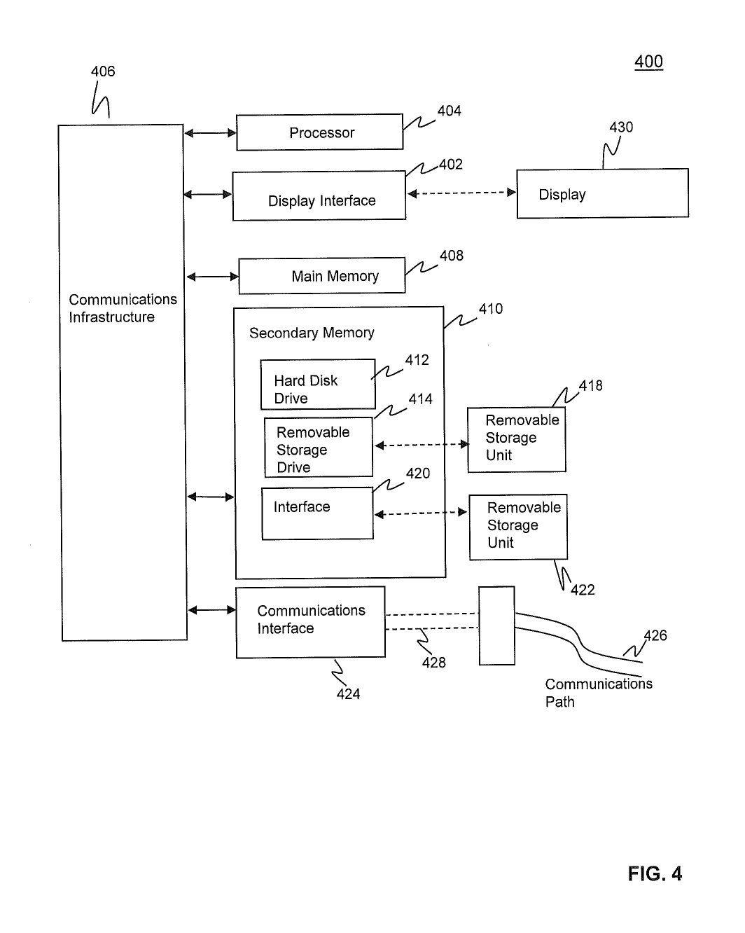

As is known in the art, and is described with respect to FIG. 4, all or part of one or more aspects of the methods and apparatus discussed herein may be distributed as an article of manufacture that itself comprises a computer-readable medium having computer-readable code means embodied thereon. The computer-readable program code means is operable, in conjunction with a computer system, to carry out all or some of the steps to perform the methods or create the apparatuses discussed herein. The computer-readable medium may be a recordable medium, for example, floppy disks, hard drives, compact disks, EEPROMs, memory cards, etc. Any tangible medium known or developed that can store information suitable for use with a computer system may be used. The computer-readable code means can be any mechanism for allowing a computer to read instructions and data, such as, for example, magnetic variations on a magnetic media or optical characteristic variations on the surface of a compact disk. The computer-readable medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, for example, by processing capability of the credit card issuer 105, the municipality device 110, and the reporting and tracking device 115, all connected with each other through the communications network 120, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

By way of example, a terminal apparatus associated with each of the credit card issuer 105, the municipality device 110, and the reporting and tracking device 115, all connected with each other through the communications network 120, could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of further example, an active file manager apparatus for processing an active file in a payment system, could include a memory, and at least one processor coupled to the memory. The processor can be operative to perform one or more method steps described herein, or otherwise facilitate their performance.

Although exemplary embodiments have been described herein in terms of a method or system/apparatus, it is contemplated that it may be implemented by microprocessors of a computer, such as, for example, the computer system 400 illustrated in FIG. 4. In various embodiments, one or more of the functions of the various components may be implemented in software that controls a computing device, such as computer system 400, which is described below with reference to FIG. 4. The processor(s) of the computer system 400 are configured to execute the software recorded on a non-transitory computer-readable recording medium, such as, for example, a hard disk drive, ROM, flash memory, optical memory, or any other type of non-volatile memory.

Aspects of the present disclosure shown in FIGS. 1-3, or any part(s) or function(s) thereof, may be implemented using, for example, hardware, software modules, firmware, tangible computer readable media having instructions stored thereon, or a combination thereof and may be implemented in one or more computer systems or other processing systems. FIG. 4 illustrates an exemplary computer system 400 in which embodiments of the present disclosure, or portions thereof, may be implemented as computer-readable code. For example, system 100 of FIG. 1 can be implemented in computer system 400 using hardware, software, firmware, non-transitory computer readable media having instructions stored thereon, or a combination thereof, and may be implemented in one or more computer systems or other processing systems. Hardware, software, or any combination of such may embody any of the modules and components used to implement the system and architecture of FIGS. 1-3. Similarly, hardware, software, or any combination of such may embody modules and components used to implement the method of FIG. 3.

If programmable logic is used, such logic may execute on a commercially available processing platform or a special purpose device. One of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. The processor devices may have one or more processor “cores”, as that term is commonly understood.

Various embodiments of the present disclosure are described in terms of the exemplary computer system 400, shown in FIG. 4. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The computer system 400 includes a display 430 operable by a user via conventional means that is connected to a communications infrastructure 406 via a display interface 402 and controlled via a processor device 404. The processor device 404 may be a special purpose or a general-purpose processor device. As will be appreciated by persons skilled in the relevant art, the processor device 404 may also be a single processor in a multi-core/multiprocessor system, such system operating alone, or in a cluster of computing devices operating in a cluster or server farm. The processor device 404 is connected to the communication infrastructure 406 which may be, for example, a bus, message queue, network, or multi-core message-passing scheme.

The computer system 400 also includes a main memory 408, for example, random access memory (RAM), and may also include a secondary memory 410. The secondary memory 410 may include, for example, a hard disk drive 412, removable storage drive 414, etc. The removable storage drive 414 may comprise, for example, a floppy disk drive, a magnetic tape drive, an optical disk drive, a flash memory, or the like.

The removable storage drive 414 reads from and/or writes to a removable storage unit 418 in a well-known manner. The removable storage unit 418 may comprise, for example, a floppy disk, magnetic tape, optical disk, etc. which is read by and written to by removable storage drive 414. As will be appreciated by persons skilled in the relevant art, the removable storage unit 418 includes a non-transitory computer usable storage medium having stored therein computer software and/or data.

In alternative implementations, the secondary memory 410 may include other similar means for allowing computer programs or other instructions to be loaded into computer system 400. Such means may include, for example, an interface 420 and a removable storage unit 422 connected thereto. Examples of such means may include, for example, a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400. The computer system 400 may also include a communications interface 424.

The communications interface 424 allows software and data to be transferred between computer system 400 and external devices. The communications interface 424 may include, for example, a modem, a network interface (such as an Ethernet card), a communications port, a PCMCIA slot and card, or the like. Software and data transferred via communications interface 424 may be in the form of signals, which may be electronic, electromagnetic, optical, or other signals capable of being received by communications interface 424. These signals may be provided to communications interface 424 via an internal connection 428 and a communications path 426. The communications path 426 carries signals and may be implemented using wire or cable, fiber optics, a phone line, a cellular phone link, an RF link or other communications channels.

In this application, the terms “computer program medium”, “non-transitory computer readable medium”, and “computer usable medium” are used to generally refer to media such as, for example, the removable storage unit 418, removable storage unit 422, and a hard disk installed in hard disk drive 412. Signals carried over the communications path 426 can also embody the logic described herein. “Computer program medium” and “computer usable medium” can also refer to memories, such as the main memory 408 and the secondary memory 410, which can be memory semiconductors (e.g., DRAMs, etc.). These computer program products are means for providing software to computer system 400.

Computer programs (also called computer control logic) are stored in the main memory 408 and/or the secondary memory 410. Computer programs may also be received via the communications interface 424. Such computer programs, when executed, enable the computer system 400 to implement the present disclosure as discussed herein. In particular, the computer programs, when executed, enable the processor device 404 to implement the processes of the present disclosure, such as the steps in the methods illustrated by flowchart of FIG. 3, discussed above. Accordingly, such computer programs represent controllers of the computer system 400. Where the present disclosure is implemented using software, the software may be stored in a computer program product and loaded into computer system 400 using removable storage drive 414, interface 420, and hard disk drive 412, or communications interface 424.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

Accordingly, it will be appreciated by one of ordinary skill in the art that one or more embodiments of the present invention can include a computer program comprising computer program code means adapted to perform one or all of the steps of any methods or claims set forth herein when such program is run on a computer, and that such program may be embodied on a computer-readable medium. Further, one or more embodiments of the present invention can include a computer comprising code adapted to cause the computer to carry out one or more steps of methods or claims set forth herein, together with one or more apparatus elements or features as depicted and described herein.

It is to be appreciated that the Detailed Description section, and not just the Summary and Abstract sections, is intended to be used to interpret the claims. The Summary and Abstract sections may set forth one or more, but not all, exemplary embodiments of the present disclosure as contemplated by the inventor(s) and, thus, are not intended to limit the present disclosure and the appended claims in any way. Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

While the present invention has described herein with particular reference to the drawings, it should be understood that various modifications could be made without departing from the spirit and scope of the present invention. Those skilled in the art will appreciate that various other modifications and alterations could be developed in light of the overall teachings of the disclosure. The presently preferred embodiments described herein are meant to be illustrative only and not limiting as to the scope of the invention which is to be given the full breadth thereof.

I/We claim:

1. A method of offering tax incentives for credit card usage, the method comprising the steps of:
partnering, between a municipality and a credit card issuer, to issue a credit card sponsored by the municipality, wherein the municipality receives a percentage of every transaction charged to the card;
tracking, by a reporting and tracking computer, card usage by the users via transactions charged to the card, wherein the card usage data is stored in a database connected to the reporting and tracking computer;
analyzing, by the reporting and tracking computer, the card usage data to determine an extent of card usage; and
offering, from a municipality computer, tax incentives, by the municipality, to users based on the analyzed card usage.

2. The method of claim 1, wherein the tax incentives are offered to users based on overall card usage by the user.

3. The method of claim 1, wherein the tax incentives are offered to users based on usage of the card by the user within the municipality.

4. The method of claim 1, wherein the tax incentives are offered to users based on a combination of overall card usage by the user and usage of the card by the user within the municipality.

5. The method of claim 1, wherein the users are individuals or business entities.

6. The method of claim 1, wherein the tax incentives increase as usage of the card increases.

7. The method of claim 1, wherein the tax incentives comprise tax discounts or not raising tax rates by the municipality.

8. The method of claim 1, furthering comprising the step of partnering, between the municipality and a local entity, to offer additional awards, other than tax incentives, to users based on card usage.

9. A system for offering tax incentives for credit card usage comprising:
a credit card issuer computing device issuing a credit card sponsored by a municipality, wherein the municipality receives a percentage of every transaction charged to the card;
a reporting and tracking computing device connected to the credit card computing device via a communications network, the reporting and tracking computing device receiving information regarding transactions charged to the card via the communications network and tracking card usage by the users, wherein the card usage data is stored in a database connected to the reporting and tracking computer, and wherein the reporting and tracking computer analyzes the card usage data to determine an extent of card usage; and
a municipality computing device connected to the reporting and tracking computing device via the communications network, the municipality computing device offering tax incentives to users based on card usage as tracked and analyzed by the reporting and tracking computing device.

10. The system of claim 9, wherein the tax incentives are offered to users based on overall card usage by the user.

11. The system of claim 9, wherein the tax incentives are offered to users based on usage of the card by the user within the municipality.

12. The system of claim 9, wherein the tax incentives are offered to users based on a combination of overall card usage by the user and usage of the card by the user within the municipality.

13. The system of claim 9, wherein the users are individuals or business entities.

14. The system of claim 9, wherein the tax incentives increase as usage of the card increases.

15. The system of claim 9, wherein the tax incentives comprise tax discounts or not raising tax rates by the municipality.

16. The system of claim 9, wherein the municipality computing device offers additional awards, other than tax incentives, to users based on card usage based on a partnership between the municipality and a local entity.
